(19) United States
(12) Patent Application Publication
(10) Pub. No.: US 2010/0250811 A1
(43) Pub. Date: Sep. 30, 2010

(54) INTERRUPT CONTROLLER AND IMAGE-FORMING DEVICE

(75) Inventors: Masakazu Kawashita, Ebina-shi (JP); Hiroaki Yamamoto, Ebina-shi (JP); Masahiko Kikuchi, Minamiashigara-shi (JP); Yuichi Kawata, Ebina-shi (JP); Yoshifumi Bando, Ebina-shi (JP); Keita Sakakura, Ebina-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/564,958

(22) Filed: Sep. 23, 2009

(30) Foreign Application Priority Data
Mar. 24, 2009 (JP) 2009-072078

(51) Int. Cl. G06F 13/24

(52) U.S. Cl. 710/260

(57) ABSTRACT

An interrupt controller includes: a timer that repeatedly measures a predesignated length of time; an interrupt request unit that, when data is received by a receiving unit while the timer is measuring the length of time, outputs an interrupt request after measurement of the length of time is completed; a measurement unit that measures a frequency of data reception of the receiving unit; and an updating unit that changes the length of time measured by the timer so as to be shorter than the predesignated length of time when the frequency of reception measured by the measurement unit exceeds a threshold frequency.

### CROSS-REFERENCE TO RELATED APPLICATIONS

This application is based on and claims priority under 35 U.S.C. 119 from Japanese Patent Application No. 2009-72078, which was filed on Mar. 24, 2009.

### BACKGROUND

1. Technical Field

The present invention relates to an interrupt controller and an image-forming device.

2. Related Art

There are known techniques for controlling the timing of an interrupt request that occurs in response to data reception.

### SUMMARY

According to an aspect of the invention, there is provided an interrupt controller including: a timer that repeatedly measures a predesignated length of time; an interrupt request unit that, when data is received by a receiving unit while the timer is measuring the length of time, outputs an interrupt request after measurement of the length of time is completed; a measurement unit that measures a frequency of data reception of the receiving unit; and an updating unit that changes the length of time measured by the timer so as to be shorter than the predesignated length of time when the frequency of reception measured by the measurement unit exceeds a threshold frequency.

### BRIEF DESCRIPTION OF THE DRAWINGS

Exemplary embodiment(s) of the present invention will be described in detail based on the following figures, wherein:

FIG. 1 is a block diagram showing the configuration of an image-forming device according to an exemplary embodiment;

FIG. 2 is a time chart describing an outline of an interrupt request process of the image-forming device;

FIG. 3 is a flowchart showing a process of an interrupt controller of the image-forming device;

FIG. 4 is a time chart describing an outline of an interrupt request process according to a modified example.

### DETAILED DESCRIPTION

Configuration

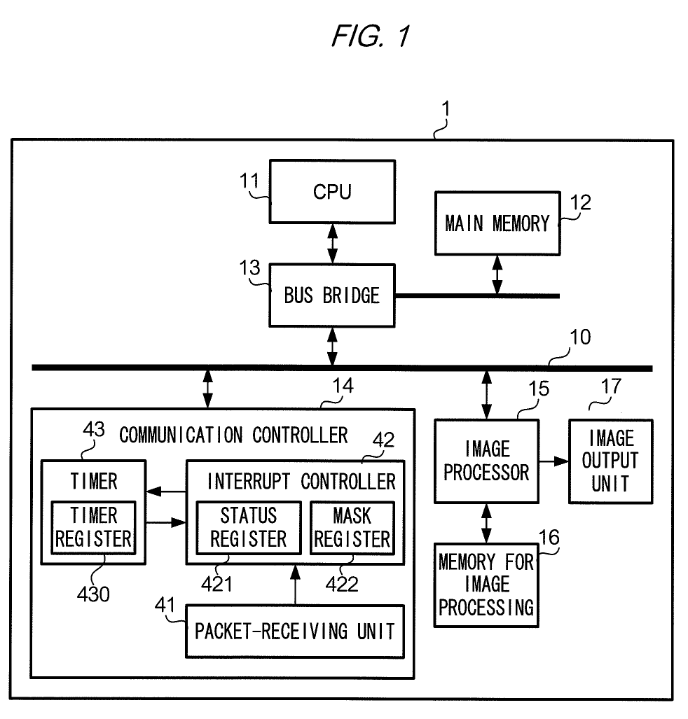

FIG. 1 is a block diagram showing the configuration of an image-forming device 1 according to the present exemplary embodiment. As shown in the figure, the image-forming device 1 includes CPU (Central Processing Unit) 11, main memory 12, bus bridge 13, communication controller 14, image processor 15, memory for image processing 16, and image output unit 17. CPU 11 controls each unit of image-forming device 1 by executing programs stored in main memory 12. Main memory 12 includes, for example, a ROM (Read Only Memory) and a RAM (Random Access Memory) and stores programs to be executed by CPU 11 along with data. Bus bridge 13 connects CPU 11 or main memory 12 with bus 10. In addition to bus bridge 13, communication controller 14 and image processor 15 are also connected to bus 10. Communication controller 14 establishes communication with an external device connected via a communication line to send and receive data. Image processor 15 implements various types of image processing using image data received by communication controller 14. Memory for image-processing 16 is used as a work area when image processor 15 implements image processing. Image output unit 17 is a printer that forms images, for example in an electrophotographic manner, and forms an image corresponding to the image data processed by image processor 15 on paper and outputs the image. Image output device 17 is one example of the image-forming unit of the present invention.

Next, the configuration of communication controller 14 will be described. Communication controller 14 is one example of the interrupt controller of the present invention. As shown in FIG. 1, communication controller 14 includes packet-receiving unit 41, interrupt controller 42, and timer 43. Packet-receiving unit 41 is one example of the receiving unit of the present invention and receives data sent from the abovementioned external device via a communication line. For example, image data is sent from the external device as a packet. Timer 43 is one example of the timer of the present invention and measures a length of time corresponding to a set value stored in timer register 430. In timer register 430, a set value corresponding to a default time is stored in advance. In the following descriptions, the set value corresponding to the default time will be referred to as the “initial value.” Interrupt controller 42 is one example of the interrupt request unit of the present invention and outputs an interrupt request when data is received by packet-receiving unit 41. At this time, interrupt controller 42 controls the timing for supplying the interrupt request based on the frequency of data reception of packet-receiving unit 41.

Interrupt controller 42 includes status register 421 and mask register 422. Status register 421 stores interrupt cause information, a count value, and a received packet count. The interrupt cause information is information indicating the cause of an interrupt that occurs in response to data reception by packet-receiving unit 41. The count value is a value that indicates the length of a period during which no packets are received by packet-receiving unit 41. The received packet count indicates the number of packets received by packet-receiving unit 41 during a period starting from a unit time before the point at which the cause of an interrupt occurs. The received packet count is counted and stored by interrupt controller 42. In addition, the received packet count is utilized as a value that represents the frequency of data reception of packet-receiving unit 41. That is, interrupt controller 42 is one example of the reception frequency measurement unit of the present invention and measures the frequency of data reception of packet-receiving unit 41. In addition, mask register 422 stores an interrupt mask bit. The interrupt mask bit is information that controls the output of an interrupt request. For example, if the interrupt mask bit is “0”, the output of an interrupt request is permitted. On the other hand, if the interrupt mask bit is “1”, the output of any new interrupt request is prohibited. In addition, in the following descriptions, prohibiting the output of an interrupt request will be referred to as “masking the interrupt request” and permitting the output of an interrupt request will be referred to as “unmasking the interrupt request”.

Operation

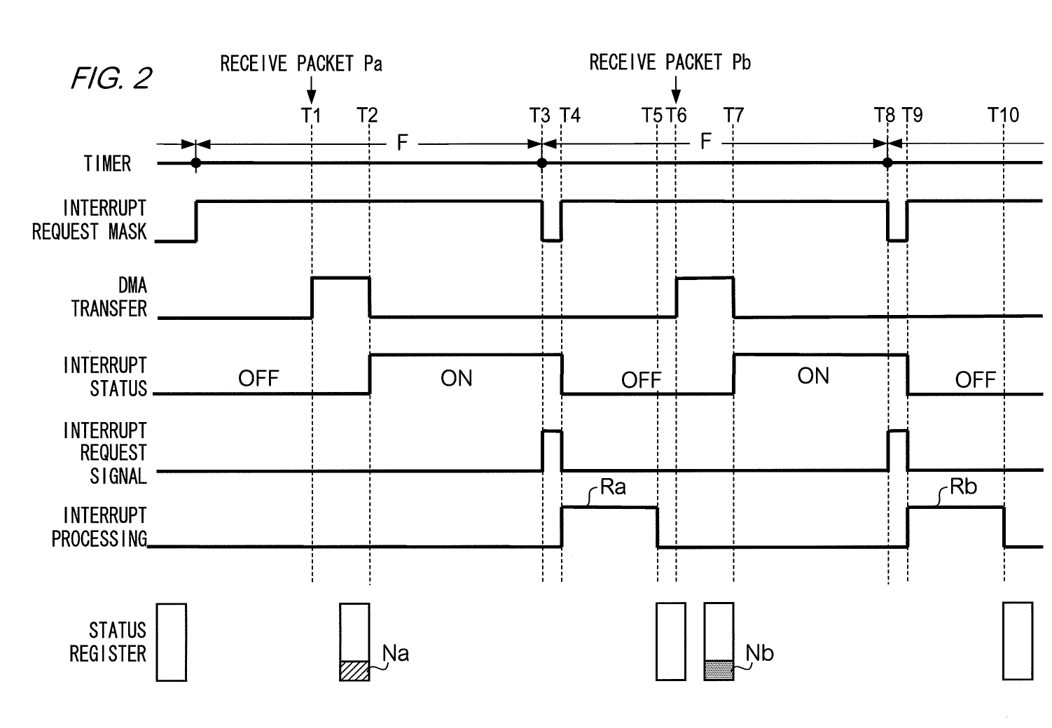

Next, operations of image-forming device 1 according to an aspect of the present exemplary embodiment will be described. In image-forming device 1, an interrupt request process is implemented in response to the reception of a packet. First, an outline of the interrupt request process will be described with reference to the time chart shown in FIG. 2. In the interrupt request process, timer 43 repeatedly measures length of time F, which corresponds to the set value stored in timer register 430. That is, timer 43 repeatedly measures a pre-designated length of time. In addition, interrupt controller 42 sets the interrupt mask bit stored in mask register 422 to “1” and masks the interrupt request each time timer 43 begins measurement of the length of time F.

When packet-receiving unit 41 receives packet Pa at time instant T1, packet Pa is DMA (Direct Memory Access) transferred to main memory 12. DMA transfer refers to a process in which communication controller 14 transfers data to main memory 12 for storage through a route that does not involve CPU 11. When packet Pa is received by packet-receiving unit 41, the interrupt controller 42 stores interrupt cause information Na, which indicates the cause of an interrupt that occurs in response to reception of packet Pa, in status register 421. Interrupt cause information Na includes an address that indicates the storage location of packet Pa within main memory 12. When interrupt cause information Na is stored in status register 421, the interrupt status is switched to “On”.

When the DMA transfer is completed at time instant T2, interrupt controller 42 waits until timer 43 finishes measuring length of time F as the interrupt mask bit stored in mask register 422 has been set to “1”. Then, when timer 43 finishes measuring length of time F at time instant T3, interrupt controller 42 sets the interrupt mask bit stored in mask register 422 to “0” and unmasks the interrupt request. Then, interrupt controller 42 outputs an interrupt request signal. That is, when data is received by packet-receiving unit 41 while timer 43 is measuring the length of time, interrupt controller 42 outputs an interrupt request after measurement of the length of time is completed. In this way, when the interrupt request signal responding to the reception of packet Pa is output, the interrupt status is turned off. Then, interrupt controller 42 sets the mask bit stored in mask register 422 to “1” and again masks the interrupt request.

When the interrupt request signal is output from interrupt controller 42 at time instant T3, the interrupt request signal is supplied to CPU 11. When the interrupt request signal is supplied at time instant T4, CPU 11 starts interrupt process Ra corresponding to interrupt cause information Na stored in status register 421. In interrupt process Ra, for example, packet Pa, which is stored in the address contained in interrupt cause information Na, is read from main memory 12, and after being read, packet Pa is supplied to image output device 17 via image processor 15. That is, CPU 11 is one example of the processor of the present invention and, when an interrupt request is output by interrupt controller 42, implements a process of supplying the image data received by receiving unit 41 to image output device 17 as an interrupt process corresponding to the interrupt request. When interrupt process Ra is completed at time instant T5, interrupt controller 42 erases interrupt cause information Na from status register 421. Subsequently, when packet-receiving unit 41 receives packet Pb at time instant T6, interrupt controller 42 and CPU 11 implement a process similar to the process described above.

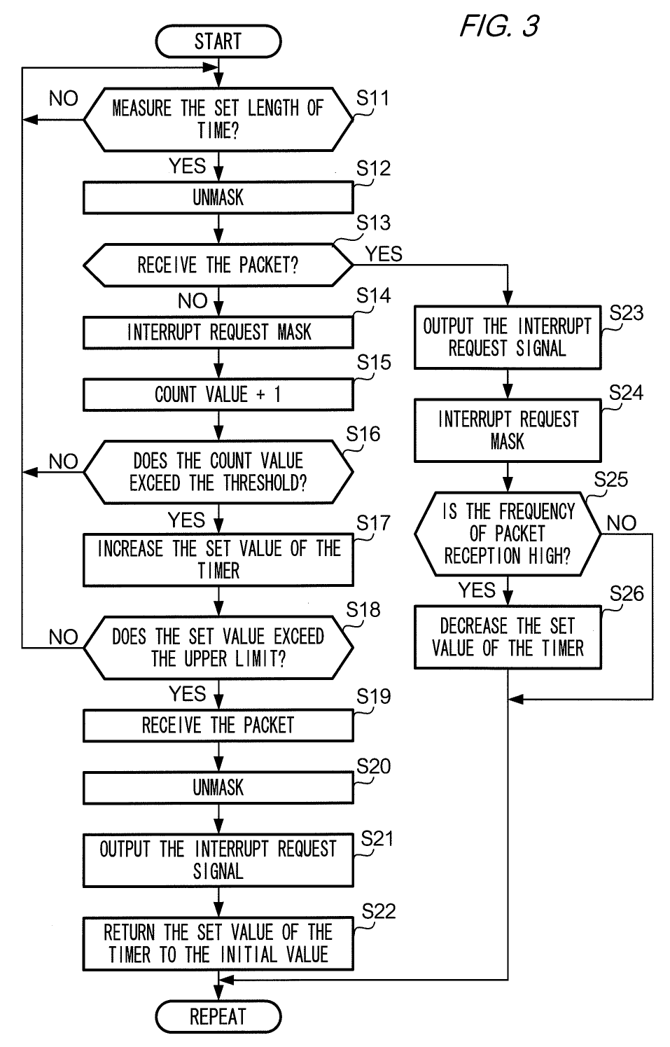

Next, a process of interrupt controller 42 will be described concretely with reference to the flowchart shown in FIG. 3. First, interrupt controller 42 determines whether timer 43 has finished measuring length of time F corresponding to the set value stored in timer register 430 (step S11). If timer 43 has not finished measuring length of time F (step S11: NO), interrupt controller 42 waits until timer 43 finishes measuring length of time F. On the other hand, if timer 43 has finished measuring length of time F (step S11: YES), interrupt controller 42 sets the interrupt mask bit stored in mask register 422 to “0” and unmasks the interrupt request (step S12). Subsequently, interrupt controller 42 determines whether a packet has been received by packet-receiving unit 41 while timer 43 was measuring length of time F (step S13).

If no packets were received while timer 43 was measuring length of time F (step S13: NO), when timer 43 restarts measurement of length of time F, interrupt controller 42 sets the interrupt mask bit stored in mask register 422 to “1” and masks the interrupt request (step S14). Subsequently, interrupt controller 42 adds 1 count to the count value stored in status register 421 (step S15). Subsequently, interrupt controller 42 determines whether the count value stored in status register 421 exceeds a threshold (step S16). If the count value is below the threshold (step S16: NO), interrupt controller 42 returns to step S11. On the other hand, if the count value exceeds the threshold (step S16: YES), interrupt controller 42 increases the set value stored in timer register 430 to increase the length of time to be measured by timer 43 (step S17). As described above, the count value is a value that represents the length of a period during which no data is received by packet-receiving unit 41. That is, interrupt controller 42 is one example of the changing unit of the present invention and changes the length of time measured by timer 43 to be longer than the predesignated length of time if no data is received by packet-receiving unit 41 for a length of time exceeding the threshold related to the length of time.

Subsequently, interrupt controller 42 determines whether the set value stored in timer register 430 exceeds the upper limit (step S18). If the set value stored in timer register 430 is below the upper limit (step S18: NO), interrupt controller 42 returns to step S11. On the other hand, if the set value stored in timer register 430 exceeds the upper limit (step S18: YES), once a new packet is received by packet-receiving unit 41 (step S19), interrupt controller 42 sets the interrupt mask bit stored in mask register 422 to “0” to unmask the interrupt request (step S20) and outputs the interrupt request signal (step S21). That is, when data is received by packet-receiving unit 41 while timer 43 is measuring a length of time, which is longer than a predetermined maximum length of time, interrupt request unit 42 outputs the interrupt request before the measurement of the length time is completed. Subsequently, interrupt controller 42 returns the set value stored in timer register 430 to the initial value (step S22) and then returns to step S11 again. That is, when data is received by packet-receiving unit 41 while timer 43 is measuring a length of time, which is longer than the predetermined maximum length of time, interrupt controller 42 changes the length of time measured by timer 43 to match the predesignated length of time.

On the other hand, in step S13, if a packet was received while timer 43 was measuring length of time F (step S13: YES), interrupt controller 42 outputs an interrupt request signal (step S23). Then, when timer 43 restarts measurement of length of time F, interrupt controller 42 sets the interrupt mask bit stored in mask register 422 to “1” and masks the interrupt request (step S24). Subsequently, interrupt controller 42 determines whether the frequency of packet reception is high based on the received packet count stored in status register 421 (step S25). For example, if the received packet count stored in status register 421 is below a threshold, interrupt controller 42 determines that the frequency of packet reception is low (step S25: NO) and returns to step S11 again. On the other hand, if the received packet count stored in status register 421 exceeds the threshold, interrupt controller 42 determines that the frequency of packet reception is high (step S25: YES). In this case, interrupt controller 42 decreases the set value stored in timer register 430 to shorten the length of time to be measured by timer 43 (step S26) and then returns to step S11 again. That is, if the measured frequency of reception exceeds the threshold related to the frequency of reception, interrupt controller 42 changes the length of time measured by timer 43 so as to be shorter than the predesignated length of time.

### Modified Examples

The above has been a description of an exemplary embodiment, but details of the exemplary embodiment may vary as follows. Moreover, each of the following modified examples may be combined as appropriate.

### Modified Example 1

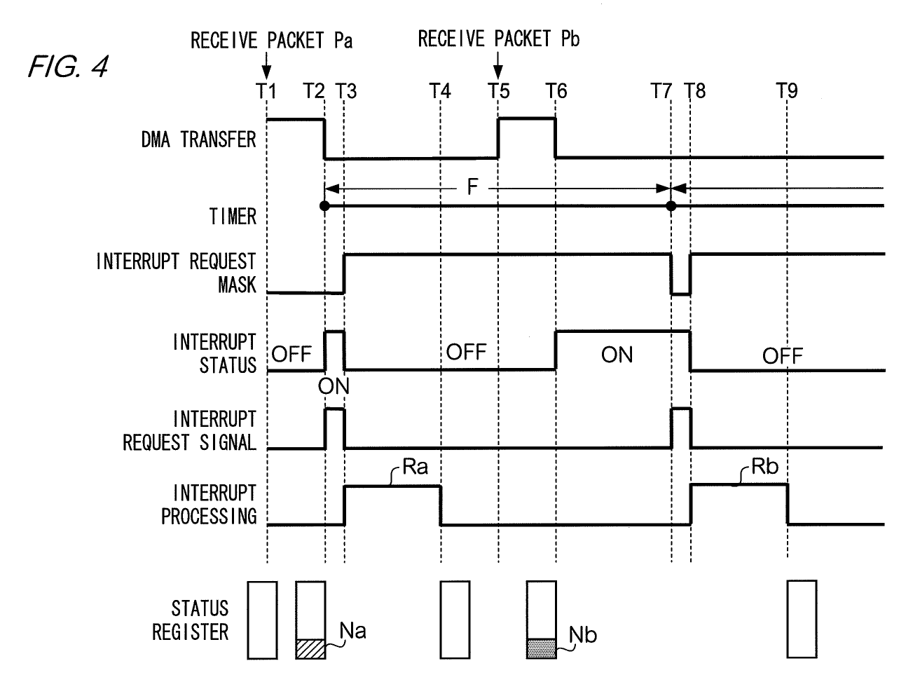

In the exemplary embodiment, timer 43 measures the length of time even while no data is being received by packet-receiving unit 41, but timer 43 may measure the length of time in response to data reception by packet-receiving unit 41. FIG. 4 is a time chart describing an outline of an interrupt request process according to an aspect of this modified example. In this interrupt request process timer 43 does not measure the length of time while no packets are being received by packet-receiving unit 41.

As in the exemplary embodiment, when packet-receiving unit 41 receives packet Pa at time instant T1, a DMA transfer of packet Pa is implemented during the period from time instant T1 to time instant T2. When the DMA transfer is completed at time instant T2, interrupt controller 42 outputs an interrupt request signal. Interrupt controller 42 also starts timer 43 at time instant T2. This operates timer 43 and starts the measurement of length of time F. That is, when the interrupt request is output by interrupt controller 42, timer 43 measures a predesignated length of time from the point at which the interrupt request was output. When timer 43 starts, interrupt controller 42 sets the mask bit stored in mask register 422 to “1” and masks the interrupt request. As in the above case, when the interrupt request signal is output from interrupt controller 42 at time instant T2, CPU 11 implements interrupt process Ra corresponding to interrupt cause information Na stored in status register 421 during the period from time instant T3 to time instant T4.

Subsequently, when packet-receiving unit 41 receives packet Pb at time instant T5, a DMA transfer of packet Pb is implemented during the period from time instant T5 to time instant T6. When the DMA transfer is completed at time instant T6, interrupt controller 42 waits until timer 43 finishes measuring length of time F as the interrupt mask bit stored in mask register 422 has been set to “1”. Then, when timer 43 finishes measuring length of time F at time instant T7, interrupt controller 42 sets the interrupt mask bit stored in mask register 422 to “0” and unmasks the interrupt request. Then, interrupt controller 42 outputs the interrupt request signal to CPU 11. In other words, interrupt controller 42 is one example of the interrupt request controller of the present invention that, when data is received by packet-receiving unit 41 while timer 43 is measuring the length of time, prohibits the output of the interrupt request until the measurement of the length of time is completed and permits the output of the interrupt request after the measurement of the length of time is completed.

In addition, because interrupt cause information Nb is stored in status register 421, interrupt controller 42 restarts timer 43 at time instant T7. This operates timer 43 again and starts the measurement of length of time F. When timer 43 starts, interrupt controller 42 sets the mask bit stored in mask register 422 to “1” and masks the interrupt request. When the interrupt request signal is output from interrupt controller 42 at time instant T7, CPU 11 implements interrupt process Rb corresponding to interrupt cause information Nb stored in status register 421 during the period from time instant T8 to time instant T9.

### Modified Example 2

In the exemplary embodiment, interrupt controller 42 may change the set value stored in timer register 430 depending on the processing capacity of CPU 11, bus 10, or main memory 12. For example, if the processing capacity of CPU 11, bus 10, or main memory 12 is high, interrupt controller 42 lowers the initial value stored in timer register 430 to shorten the length of time to be measured by timer 43. On the other hand, if the processing capacity of CPU 11, bus 10, or main memory 12 is low, interrupt controller 42 increases the initial value stored in timer register 430 to increase the length of time to be measured by timer 43. In addition, interrupt controller 42 measures the utilization rate of the CPU at predetermined time intervals, and if the measured utilization rate is high, it increases the set value stored in timer register 430, whereas if the measured utilization rate is low, it may lower the set value stored in timer register 430.

### Modified Example 3

In the exemplary embodiment, interrupt controller 42 measures the frequency of packet reception by packet-receiving unit 41, but the main unit that measures the frequency of packet reception is not limited to this. For example, a circuit that measures the frequency of packet reception may be separately installed in communication controller 14.

Moreover, in the exemplary embodiment, the number of packets received by packet-receiving unit 41 during a period starting from a unit time before the point at which the cause of an interrupt occurs is used as the frequency of packet reception by the packet-receiving unit 41, but the value used as the frequency of packet reception is not limited to this. For example, independently of the timing at which the cause of an interrupt occurs, the number of packets received per unit time by packet-receiving unit 41 may be counted at predetermined time intervals and used as the frequency of packet reception. In addition, if interrupt requests are output in response to high-priority packets from among the packets received by packet-receiving unit 41, the number of high-priority packets received by packet-receiving unit 41 may be used as the frequency of data reception.

### Modified Example 4

Timer 43 may be a subtraction timer that measures the time corresponding to the set value through subtraction operations, or it may be an addition timer that measures the time corresponding to the set value through addition operations.

### Modified Example 5

In the exemplary embodiment, interrupt controller 42 controls timer 43, but in addition to interrupt controller 42, CPU 11 may also control timer 43. In this case, CPU 11 may change the set value stored in timer register 430 in a manner similar to interrupt controller 42. Moreover, in the exemplary embodiment, interrupt controller 42 includes status register 421 and mask register 422, but in addition to interrupt controller 42, CPU 11 may also include these units. In this case, CPU 11 and communication controller 14 are coordinated to function as the interrupt controller of the present invention.

### Modified Example 6

In the exemplary embodiment, processes of communication controller 14 may be implemented using a single or multiple hardware resources or may be implemented by the execution of one or multiple programs by CPU 11. In addition, such programs may be provided by being stored on computer-readable recording media, including magnetic recording media, such as a magnetic tape or a magnetic disk, optical recording media, such as an optical disk, magneto-optical recording media, or a semiconductor memory. It is also possible to allow such programs to be downloaded via communication lines such as the Internet.

The foregoing description of the embodiments of the present invention is provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An interrupt controller comprising:
a timer that repeatedly measures a predesignated length of time;
an interrupt request unit that, when data is received by a receiving unit while the timer is measuring the length of time, outputs an interrupt request after measurement of the length of time is completed;
a measurement unit that measures a frequency of data reception of the receiving unit; and
an updating unit that changes the length of time measured by the timer so as to be shorter than the predesignated length of time when the frequency of reception measured by the measurement unit exceeds a threshold frequency.

2. An interrupt controller comprising:
an interrupt request unit that outputs an interrupt request when data is received by a receiving unit;
a timer that measures a predesignated length of time starting from a point at which an interrupt request is output when the interrupt request is output by the interrupt request unit;
a request controller that, when data is received by the receiving unit while the timer is measuring the length of time, prohibits the output of the interrupt request until measurement of the length of time is completed and permits the output of the interrupt request after measurement of the length of time is completed;
a measurement unit that measures the frequency of data reception of the receiving unit; and
an updating unit that changes the length of time measured by the timer so as to be shorter than the predesignated length of time when the frequency of reception measured by the measurement unit exceeds a threshold frequency.

3. The interrupt controller according to claim 1, wherein the updating unit changes the length of time measured by the timer so as to be longer than the predesignated length of time when no data is received by the receiving unit for a length of time exceeding a threshold length of time.

4. The interrupt controller according to claim 2, wherein the updating unit changes the length of time measured by the timer so as to be longer than the predesignated length of time if no data is received by the receiving unit for a length of time exceeding a threshold length of time.

5. The interrupt controller according to claim 3, wherein:
the interrupt request unit outputs an interrupt request before measurement of the length of time is completed when data is received by the receiving unit while the timer is measuring a length of time exceeding a predesignated maximum length of time; and
the updating unit changes the length of time measured by the timer to match the predesignated length of time when data is received by the receiving unit while the timer is measuring the length of time exceeding the predesignated maximum length of time.

6. The interrupt controller according to claim 4, wherein:
the interrupt request unit outputs an interrupt request before measurement of the length of time is completed when data is received by the receiving unit while the timer is measuring a length of time exceeding a predesignated maximum length of time; and
the updating unit changes the length of time measured by the timer to match the predesignated length of time when data is received by the receiving unit while the timer is measuring the length of time exceeding the predesignated maximum length of time.

7. An image-forming device comprising:
a receiving unit that receives image data;
an image-forming unit that forms an image based on the supplied image data on a recording medium;
a timer that repeatedly measures a predesignated length of time;
an interrupt request unit that outputs an interrupt request after measurement of a length of time is completed when data is received by the receiving unit while the timer is measuring the length of time;
an interrupt execution unit that initiates an interrupt process by supplying the image data received by the receiving unit to the image-forming unit when an interrupt request is output;
a measurement unit that measures the frequency of data reception of the receiving unit; and
an updating unit that changes the length of time measured by the timer so as to be shorter than the predesignated length of time when the frequency of reception measured by the measurement unit exceeds a threshold frequency.

8. An image-forming device comprising:
a receiving unit that receives image data;
an image-forming unit that forms an image based on the supplied image data on a recording medium;
an interrupt request unit that outputs an interrupt request when data is received by a receiving unit;
a timer that measures a predesignated length of time starting from a point at which an interrupt request is output when the interrupt request is output by the interrupt request unit;
a request controller that, when data is received by the receiving unit while the timer is measuring the length of time, prohibits the output of the interrupt request until measurement of the length of time is completed and permits the output of the interrupt request after measurement of the length of time is completed;
an interrupt execution unit that initiates an interrupt process by supplying the image data received by the receiving unit to the image-forming unit when an interrupt request is output;
a measurement unit that measures the frequency of data reception of the receiving unit; and
an updating unit that changes the length of time measured by the timer so as to be shorter than the predesignated length of time when the frequency of reception measured by the measurement unit exceeds a threshold frequency.

9. The interrupt controller according to claim 7, wherein the updating unit changes the length of time measured by the timer so as to be longer than the predesignated length of time if no data is received by the receiving unit for a length of time exceeding a threshold length of time.

10. The interrupt controller according to claim 8, wherein the updating unit changes the length of time measured by the timer so as to be longer than the predesignated length of time if no data is received by the receiving unit for a length of time exceeding a threshold related to the length of time.

11. The interrupt controller according to claim 9, wherein:
the interrupt request unit outputs an interrupt request before measurement of the length of time is completed when data is received by the receiving unit while the timer is measuring a length of time exceeding a predesignated maximum length of time; and
the updating unit changes the length of time measured by the timer to match the predesignated length of time when data is received by the receiving unit while the timer is measuring the length of time exceeding the predesignated maximum length of time.

12. The interrupt controller according to claim 10, wherein:
the interrupt request unit outputs an interrupt request before measurement of the length of time is completed when data is received by the receiving unit while the timer is measuring a length of time exceeding a predesignated maximum length of time; and
the updating unit changes the length of time measured by the timer to match the predesignated length of time when data is received by the receiving unit while the timer is measuring the length of time exceeding the predesignated maximum length of time.
